(19) United States
(12) Patent Application Publication
(10) Pub. No.: US 2022/0368528 A1
(43) Pub. Date: Nov. 17, 2022

(54) ESTABLISHING AUTHENTIC REMOTE PRESENCE USING TOKENS

(71) Applicant: Microsoft Technology Licensing, LLC, Redmond, WA (US)

(72) Inventors: Ramachandra Ravitej VENNAPUSA, Bothell, WA (US); Sai Pujitha GUTHI RAJENDRAN, Redmond, WA (US); Sergii GUBENKO, Sammamish, WA (US); Balaji KRISH, Redmond, WA (US); Aleksandr TOKAREV, Sammamish, WA (US); Adrian FREI, Seattle, WA (US)

(21) Appl. No.: 17/320,367

(22) Filed: May 14, 2021

(51) Int. Cl. H04L 9/32; H04L 9/30

(52) U.S. Cl. CPC H04L 9/3213; H04L 9/3268; H04L 9/3073

(57) ABSTRACT

Authentic remote presence for a user located at a source computer is established at a target computer without requiring transmission of the user password from the source computer to the target computer, and without requiring that the user be previously credentialed at the target. The presence established at the target computer will be recognized by a security domain identity provider as authentic, allowing the user to work remotely on the source computer as if the user was physically present at the target computer even when the source and target are miles apart. The remote access presence may be bound to the particular source and target computers, such that the presence credentials can only be used for remote access from the source through the target into the security domain. The remote access functionality will work with a wide variety of operating systems, on both desktop and mobile platforms.

### BACKGROUND

Noon Remote access to a computer may involve a person being physically present at a computer X while they interact with a distant computer Y as if they were physically at Y's location. The distance between X and Y may be as little as a few hundred feet, but more often is miles.

Remote access may be authorized in various scenarios. For instance, in one scenario an employee works from home at a location X with data stored on a business computer that is miles away at location Y. In another scenario, a technician at location X performs problem diagnosis or maintenance operations on a remote computer at location Y. Other scenarios are also possible.

In a given remote access scenario, images to be drawn on computer Y's screen may be transmitted over a network to be drawn instead, or in addition, on computer X's screen where a person using Y is actually physically present. Similarly, keys typed at computer X may be transmitted over the network and be fed to computer Y as if they had been typed originally at computer Y. With some networks and some remote access software, the lag is kept low and the screen resolution is kept high, so work can be done remotely with adequate fidelity to comparable work that is not remote, and productivity is enhanced by the ability to work remotely from a variety of locations.

Despite these advancements, improvements are still possible in the field of computing for accessing and using a remote machine.

### SUMMARY

Some embodiments described herein use or provide a hardware and software combination which is configured for remote presence establishment, or usage of a remote system, or both. The combination includes a digital memory, and a processor which is in operable communication with the memory. The processor is configured, e.g., by tailored software, to perform remote presence establishment steps, which include generating a binding key pair configured to bind a source computer (local) with a target computer (remote), obtaining a nested access token formed by an identity provider based on at least the binding key pair and a target identifier, signing at least the nested access token with the binding key to produce a signed envelope, and sending the signed envelope to the target to provide the target with one or more credentials which support an authenticated or authenticatable (i.e., authentic) presence (identity) at the target.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating aspects of a computing system which has a source computing system configured to establish an authentic presence at a target computing system;

FIG. 3 is a block diagram illustrating some aspects of remote presence in some computing environments;

FIG. 4 is a flowchart illustrating steps in some presence establishment methods;

FIG. 5 is a flowchart further illustrating steps in some presence methods, incorporating FIG. 4 and steps illustrated by FIGS. 6 to 12;

FIG. 6 is a cross-functional diagram illustrating a set of presence establishment methods collectively designated herein as “V1” presence establishment methods;

FIG. 7 is a cross-functional diagram illustrating a set of presence establishment methods collectively designated herein as “V2” presence establishment methods;

FIG. 8 is a cross-functional diagram illustrating a set of presence establishment methods collectively designated herein as “V3 for cached logon” presence establishment methods;

FIG. 9 is a cross-functional diagram illustrating a set of presence establishment methods collectively designated herein as “ESTS” or “ESTS V1” presence establishment methods;

FIG. 10 is a cross-functional diagram illustrating a set of presence establishment methods collectively designated herein as “ESTS V2” presence establishment methods;

FIG. 11 is a cross-functional diagram illustrating a set of presence establishment methods collectively designated herein as “ESTS V3” presence establishment methods; and

FIG. 12 is a cross-functional diagram illustrating a set of presence establishment and usage methods collectively designated herein as “High Level” presence methods.

### DETAILED DESCRIPTION

Overview

Innovations may expand beyond their origins, but understanding an innovation's origins can help one more fully appreciate the innovation. In the present case, some teachings described herein were motivated by Microsoft innovators who recognized and faced technical challenges arising from their efforts to make remote access more effective and easier to use.

In particular, although Remote Desktop Protocol (RDP) has proven to be useful in many scenarios, Microsoft continually seeks improvements in remote access and related technologies. For example, Microsoft is moving to various kinds of passwordless operation which conventional RDP does not support. Passwordless operation provides better security in many scenarios even when passwords have been encrypted, and passwordless operation may be more convenient for users as well. Accordingly, one technical challenge is how to support remote access in a passwordless manner.

Conventional RDP has also been reliant on Kerberos, NTLM authentication, or PKU2U, which have inherent limitations. Accordingly, another technical challenge is how to support remote access without being subject to all the limitations that are inherent in Kerberos, NTLM authentication, or PKU2U.

The present disclosure provides answers to these and other questions, in the form of several token-based remote access functionalities which may be used in various combinations with one another, or alone, in a given embodiment. In particular, multiple versions of presence establishment data flow using access tokens are described in detail herein, giving a person a skill a collection of remote access presence establishment options to choose from in any given scenario.

Operating Environments

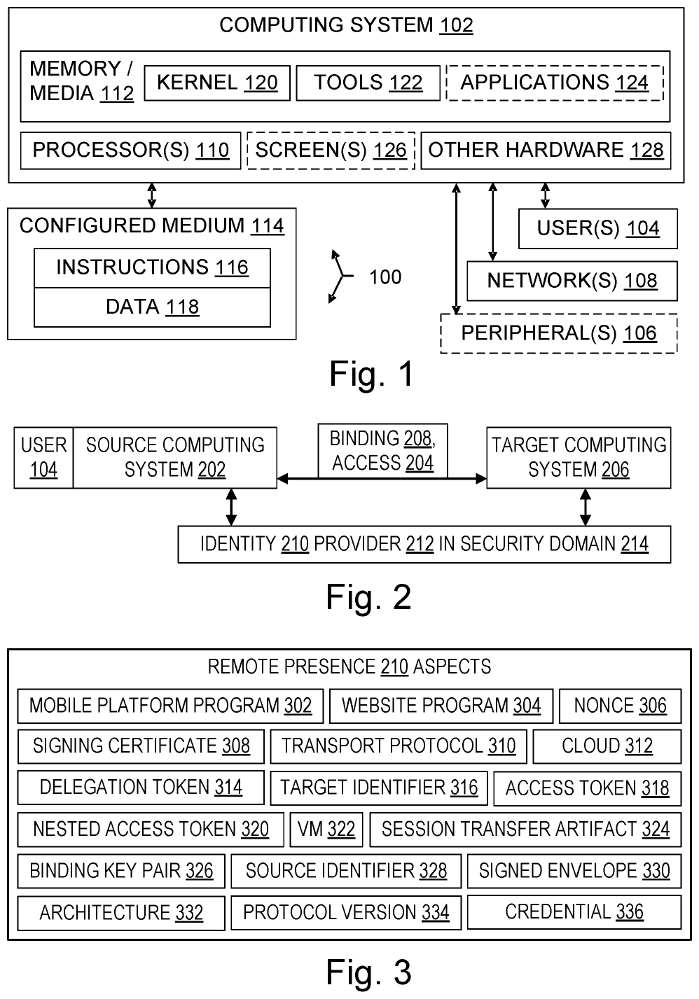

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, remote access functionality could be installed on an air gapped network and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

FIG. 2 illustrates a computing system 102 configured by one or more of the remote access enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. The illustrated system 202 includes hardware such as a processor 110, memory 112, and display 126, as well as one or more I/O device peripherals 106 such as a keyboard, mouse, microphone, or speakers.

In some embodiments, the remote access enhancements provide a user 104 who is physically located at the source computing system 202 with access 204 to a target computing system 206 that is physically remote from the source 202. For purposes herein, “remote” means physically remote unless otherwise stated, and means that the source and the target are at least one hundred feet apart in terms of straight-line distance.

In some embodiments, the access functionality 204 is bound 208 to the pair of computers 202 and 206. One may also say that the target 206 is bound 208 to the source 202, or vice versa. This binding 208 means that the access functionality 204 does not work fully (and presumptively does not work at all) if a different computer is substituted for the source 202 or the target 206 or both.

In some embodiments the access functionality 204 provides the source user with authentic access to the target, which may also be referred to as an authentic presence or an authentic identity 210 at the target. A presence at the target 206 is authentic with respect to a security domain 214 when the presence 210 is recognized as legitimate by an identity provider 212 or another security infrastructure in the security domain, or would be thus recognized at or after login.

In FIG. 3 shows some aspects of some remote identity presence. This is not a comprehensive summary of all presence aspects or of every authentic identity. These items are discussed at various points herein, and additional details regarding them are provided in the discussion of a List of Reference Numerals later in this disclosure document.

Some embodiments use or provide a functionality-enhanced system, such as system 202 or another system 102 that is enhanced as taught herein. In some embodiments, an enhanced system is configured for providing 506 credentials to establish a presence at a target computing system (“target”), the presence configured for authentication to a security domain 214 having an identity provider computing system (“identity provider”) 212. The enhanced source 202 includes a digital memory 112, and a processor 110 in operable communication with the memory. The processor 110 is configured to perform remote presence establishment steps including generating 402 a binding key pair 326 configured to bind 208 the source 202 with the target 206, obtaining 404 a nested access token 320 formed by the identity provider 212 based on at least the binding key pair and a target identifier 316, signing 406 at least the nested access token with the binding key to produce a signed envelope 330, and sending 408 the signed envelope to the target to provide the target with one or more credentials 336 which support the presence 210 at the target.

In some embodiments, the nested access token 320 includes a delegation token 314 that is formed based on at least the binding key pair 326 and an access token 318 that is based on at least the target identifier 316.

In some embodiments, the delegation token 314 includes a session transfer artifact 324. In some embodiments, the delegation token 314 includes a source identifier 328 which is unique to the source 202.

In some embodiments, the nested access token 320 is signed with at least one of the following signing certificates 308: a cloud tenant root certificate, a global identity provider certificate.

In some embodiments, at least one of the following architecture 332 conditions is satisfied: the source is configured for operation as a client in a client-server computing architecture; the source is configured for operation as a peer in a peer-to-peer computing architecture; the source is configured for operation as a cluster or a portion of a cluster in a cluster computing architecture; the source is configured for communication with the target in a cloud computing architecture; the source and target include respective machines which are physically separated from one another by at least ten feet; or the source comprises a virtual machine 322.

In some embodiments, at least one of the following architecture 332 conditions is satisfied: the source is configured for operation using a different kind of kernel 120 than the target; or the remote presence establishment steps are kernel agnostic.

Other system embodiments are also described herein, either directly or derivable as system versions of described processes or configured media, duly informed by the extensive discussion herein of computing hardware.

Although specific examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different technical features, protocols, cryptologic functions, operational sequences, data structures, or other functionalities for instance, and may otherwise depart from the examples provided herein.

Processes (a.k.a. Methods)

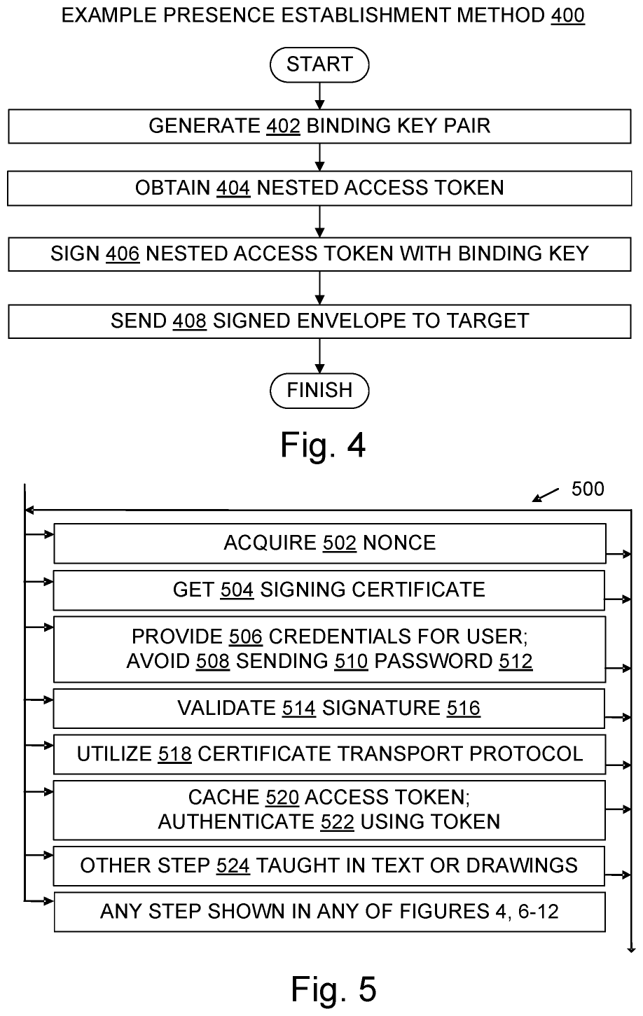

FIG. 4 illustrates a family of methods 400 that may be performed or assisted by an enhanced system, such as system 202 or another remote access functionality enhanced system as taught herein. FIG. 5 further illustrates remote access methods (which may also be referred to as “processes” in the legal sense of that word) that are suitable for use during operation of one or more systems equipped with innovative functionality taught herein. FIG. 5 includes some refinements, supplements, or contextual actions for steps shown in FIG. 4 and FIGS. 6 through 12, and incorporates the steps of those Figures as options.

Technical processes shown in the Figures or otherwise disclosed will be performed automatically, e.g., by an enhanced source 202, unless otherwise indicated. Processes may also be performed in part automatically and in part manually to the extent action by a human person is implicated, e.g., in some embodiments a human may select the target 206 from a displayed list, but no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 4 and 5. Steps may be performed serially, in a partially overlapping manner, or fully in parallel. In particular, the order in which flowchart 400 or 500 action items are traversed to indicate the steps performed during a process may vary from one performance of the process to another performance of the process. The flowchart traversal order may vary from one process embodiment to another process embodiment. Operational sequences may differ from those shown in FIGS. 4 through 12. Steps may also be omitted, combined, renamed, regrouped, be performed on one or more machines, or otherwise depart from the illustrated flow, provided that the process performed is operable and conforms to at least one claim.

Some embodiments use or provide a method for providing credentials to establish a remote presence configured for authentication to a security domain. Some methods include the following steps: generating 402 a binding key pair configured to bind a source computing system with a target computing system; obtaining 404 a nested access token based on at least the binding key pair and a target identifier; acquiring 502 an identity provider nonce 306; acquiring 502 a target nonce 306; producing a signed envelope at least in part by digitally signing 406 the nested access token, the identity provider nonce, and the target nonce together using the binding key; and electronically sending 408 the signed envelope toward the target computing system.

In some embodiments, the method further includes getting 504 a cloud tenant root certificate; and validating 514 that at least a target identifier portion of the nested access token has been signed using the cloud tenant root certificate.

In some embodiments, the method further includes utilizing 518 a certificate transport protocol 310 that includes a transport layer security handshake.

In some embodiments, the method further includes the target computing system being authenticated 522 to the security domain using the nested access token.

In some embodiments, the method provides one or more credentials 336 for a user, and the target computer system was free of any valid credentials for the user to authenticate 522 to the security domain prior to the sending 408 of the nested access token to the target computing system.

In some embodiments, the method provides one or more credentials 336 for a user, and the method avoids 508 sending any password 512 of the user from the source computing system to the target computing system.

In some embodiments, the method is performed by a website program 304. In some, the method is performed by a mobile platform program 302.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as a binding key pair 326, nested access token 320, signing certificate 308, and other items shown in FIG. 3 or implementing any of FIGS. 4 through 12, for example, in the form of data 118 and instructions 116, read from a removable storage medium 114 and/or another source such as a network connection, to form a configured storage medium. The configured storage medium 112 is capable of causing a computer system 102 to perform technical process steps for remote access, as disclosed herein. The Figures thus help illustrate configured storage media embodiments and process (a.k.a. method) embodiments, as well as system and process embodiments. In particular, any of the process steps illustrated in FIGS. 4 through 12, or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a computing system to perform a method for providing one or more credentials to establish a remote presence configured for authentication to a security domain. This method includes: generating 402 a binding key pair configured to bind a source computing system with a target computing system; obtaining 404 a nested access token based on at least the binding key pair and a target identifier; acquiring 502 an identity provider nonce; acquiring 502 a target nonce; producing a signed envelope at least in part by digitally signing 406 the nested access token, the identity provider nonce, and the target nonce together using the binding key; and electronically sending 408 the signed envelope toward the target computing system.

In some embodiments, the method provides one or more credentials 336 which are bound, e.g., are specifically effective for the target computing system in that the credentials are ineffective for authentication to the security domain of any computing system which is not the target computing system, and the credentials are effective for authentication by the target computing system to the security domain.

In some embodiments, the method further includes: caching 520 the nested access token at the target computing system; and authenticating 522 to the security domain using the cached nested access token.

In some embodiments, at least one of the following reside in a cloud 312: the source computing system 202, or the target computing system 206.

In some embodiments, the method further includes negotiating a protocol version 334.

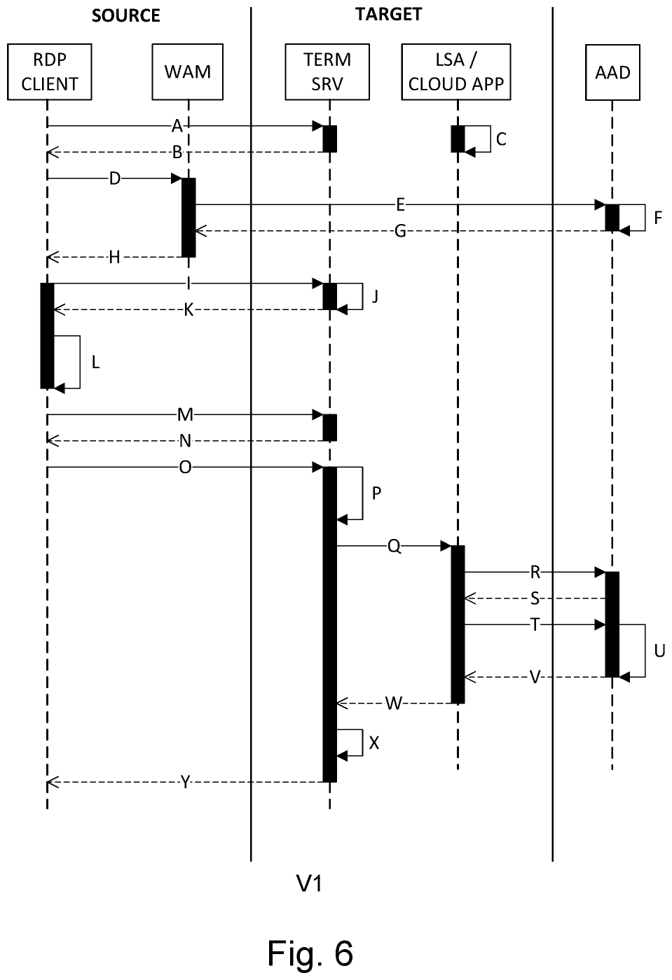

Textual Description of Steps in FIG. 6 Through 12

To aid compliance with patent figure format regulations, FIGS. 6 to 12 include letter designations for the steps they depict, as opposed to including textual step descriptions within those Figures. Text which corresponds to the letter designations is provided below. This textual description for FIGS. 6 through 12 is not presented in isolation, but is instead meant to be understood by one of skill in the context of the full present disclosure, including without limitation all text and all drawing figures herein.

FIG. 6 (V1)

A: 1. Negotiate Protocol Version

B: V4

C: Update device P2P cert

D: 2. Request Delegation Token; BK

E: 3. Request delegation token; Client Binding Key Pub; Target Device FQDN

F: Find Target device in the directory by FQDN

G: S[DT, Client BKpub, User SID]Tenant P2P Root Cert; Tenant P2P Root Cert;

H: DT; Tenant P2P Root Cert

I: 4. TLS Handshake

J: Use Device P2P certificate for TLS handshake

K: Target P2P Cert

L: a. Validate Target Device FQDN; b. Validate Target Device P2P Certificate

M: 5. request TS nonce

N: TS nonce

O: 6. S[S[DT, Client BKpub, User SID]Tenant Root Cert, TS nonce]BK

P: a. Validate Client BK signature; b. Validate Tenant Cert Signature; c. Validate TS nonce; d. Package DT cred buffer

Q: 7. Login (DT cred buffer)

R: 8. Request nonce

S: nonce

T: 9. S[DT, nonce]DK

U: a. Validate Device signature, match device in DT and device cert; b. Validate nonce

V: PRT; TGT

W: 10. NT Token

X: 11. Check that user SIDs in the NT Token and P2P User Cert are the same

Y: OK

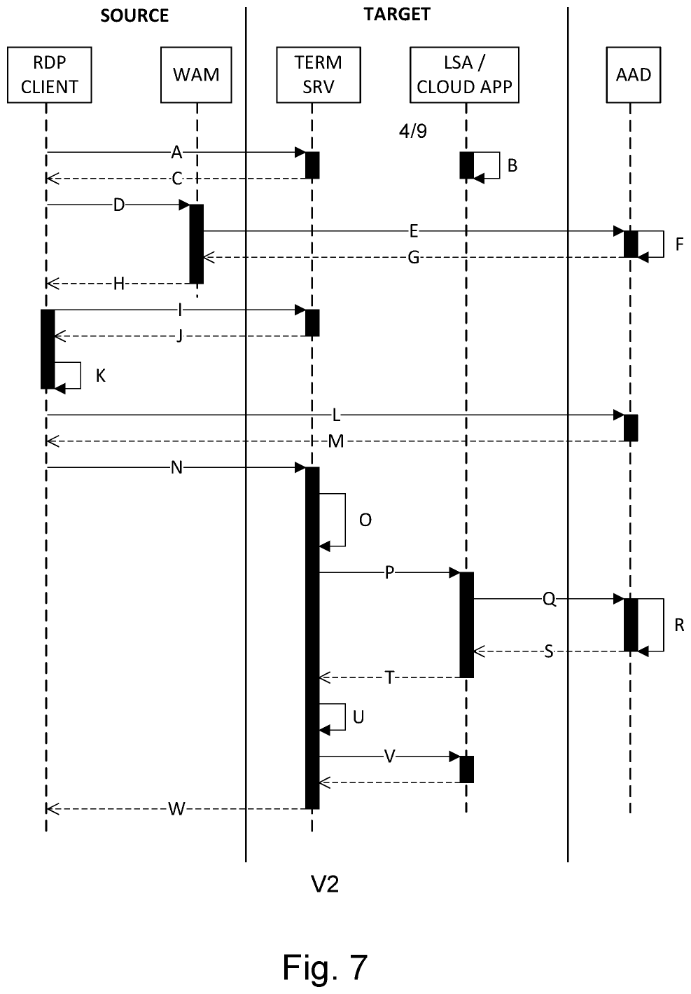

FIG. 7 (V2)

A: 1. Negotiate Protocol Version

B: 0. Update device P2P cert

C: V4

D: 2. Request Delegation Token; Client Binding Key Pub

E: 3. Request delegation token; Client Binding Key Pub; Target Device FQDN \ Device ID

F: Find Target device in the directory by FQDN

G: DT[Client Binding Key]; Tenant P2P Root Cert; S[SHA256(DT),Target Device ID, User ID, Tenant ID]P2P Root Cert

H: DT Envelope; Tenant P2P Root Cert

I: 4. TLS Handshake

J: Target Device P2P Cert

K: a. Validate Target Device P2P Certificate; b. Validate Target Device ID

L: 5. Request nonce

M: nonce

N: 6. S[DT, nonce]Bk;S[SHA(256), Target Device ID . . . ]P2PRootCert

O: 7. TS validates the RDP client logon request: a. Validate P2P Root Cert Signature; b. Match DT hash to the DT supplied; c. Match Target Device ID in the DT Envelope; d. Package S[DT, nonce]Bk cred buffer

P: 8. Network Login (DT cred buffer)

Q: 9. S[S[DT, nonce]Bk]DK

R: a. Validate Device signature, match device in DT and device cert; b. Validate Client Binding Key signature, use the binding key from DT; c. Validate nonce

S: PRT; TGT

T: 10. NT Token

U: 11. a. Check that user SIDs in the NT Token and P2P User Cert are the same; b. Authorize the user

V: 12 Interactive logon

W: OK

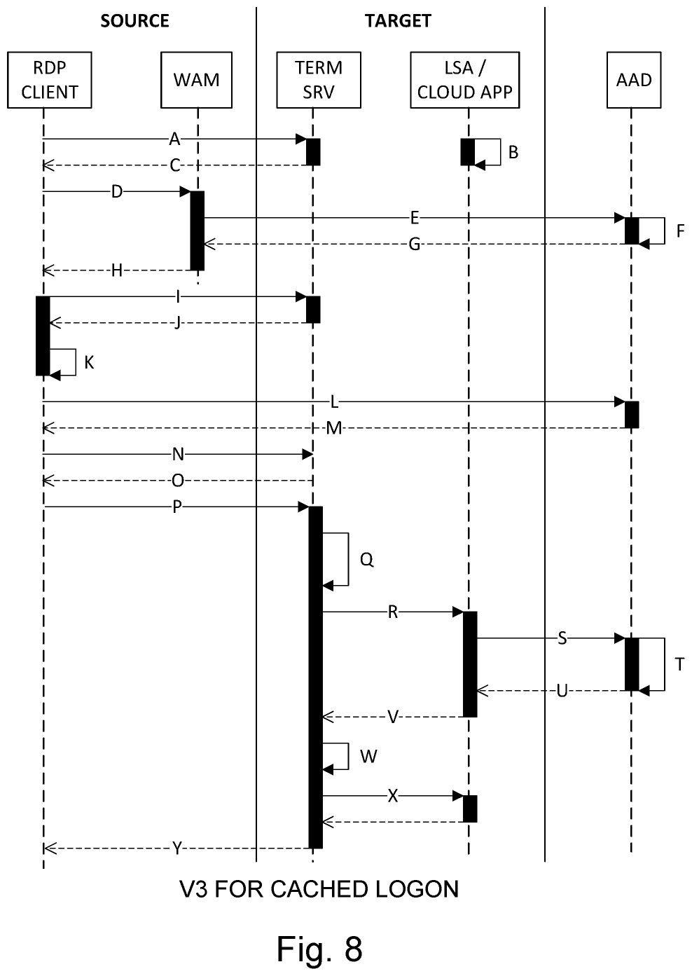

FIG. 8 (V3 for cached logon)

A: 1. Negotiate Protocol Version

B: 0. Update device P2P cert

C: V4

D: 2. Request Delegation Token; SHA256(Client Binding Key Pub)

E: 3. UserCreds, Request delegation token; SHA256(Client Binding Key Pub/Bk); Target Device FQDN \ Device ID

F: Find Target device in the directory by FQDN

G: DT[SHA256(Bk), User ID (RT)]; Tenant P2P Root Cert; S[SHA256(DT),Target Device ID, User ID, Tenant ID, SHA256(Bk)]P2P Root Cert

H: DT Envelope; Tenant P2P Root Cert, AT

I: 4. TLS Handshake

J: Target Device P2P Cert

K: a. Validate Target Device P2P Certificate; b. Validate Target Device ID

L: 5. Request nonce

M: Nonce AAD

N: 6. Request Nonce

O: Nonce TS

P: 7. S[DT, Nonce AAD, Nonce TS]Bk, AT, Bk

Q: 8. TS validates the RDP client logon request: a. Validate P2P Root Cert Signature of AT; b. Match DT hash to the DT supplied; c. Match Target Device ID in the DT Envelope; d. Validate Nonce TS; e. Package S[DT, Nonce AAD, Nonce TS]Bk, Bk via cred buffer

R: 9. Network Login (DT cred buffer)

S: 10. S[S[DT, Nonce AAD, Nonce TS]Bk, Bk]DK

T: a. Validate Device signature, match device in DT and device cert; b. Validate Client Binding Key signature, use the binding key from DT; c. Validate nonce

U: PRT; TGT

V: 11. NT Token

W: 12. a. Check that user SIDs in the NT Token and P2P User Cert are the same; b. Authorize the user

X: 13 Interactive logon

Y: OK

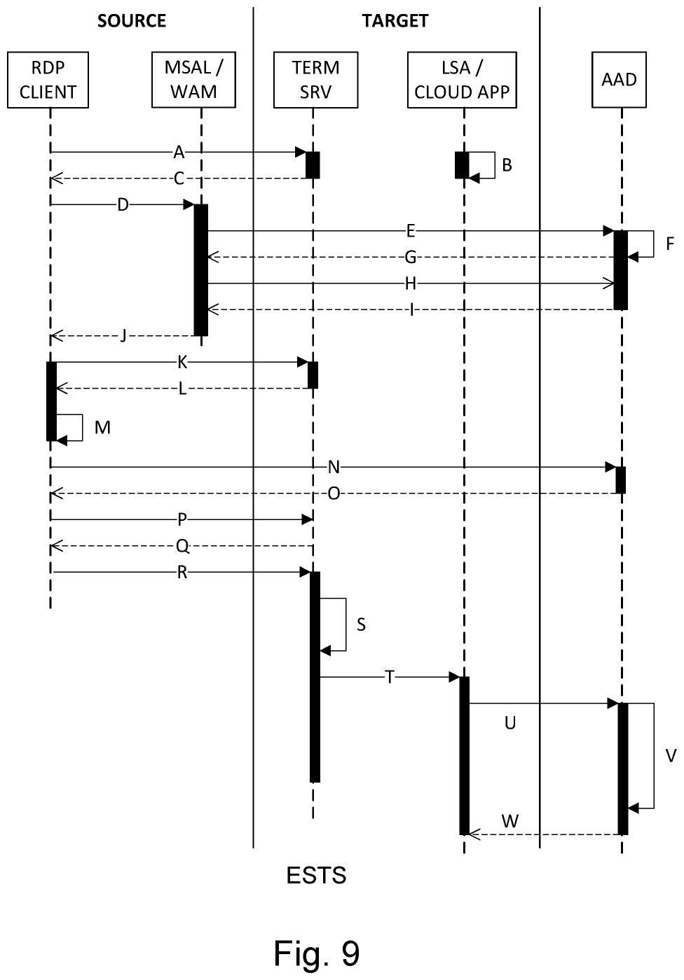

FIG. 9 (eSTS)

A: 1. Negotiate Protocol Version

B: 0. Update device P2P cert

C: V4

D: 2. Request Delegation Token; SHA256(Client Binding Key Pub)

E: 3. /authorize?target_device_hostname

F: a. Find Target device in the directory by FQDN; fail if multiple found. b. If PRT found; interrupt for username-password. c. [Pending] If required to show device-consent; interrupt.

G: auth-code

H: /token?token_type=rdp&req_cnf=<client-binding-key-pub>

I: token_type=rdp&access_token=eyj..&additional_tokens={rdp_refresh_token=xxx}&x5c_ca=<tenant P2P root cert>

J: DT Envelope; Tenant P2P Root Cert, AT

K: 4. TLS Handshake

L: Target Device P2P Cert

M: a. Validate Target Device P2P Certificate; b. Validate Target Device ID

N: 5. Request nonce

O: Nonce AAD

P: 6. Request Nonce

Q: Nonce TS

R: 7. S[DT, Nonce AAD, Nonce TS]Bk; AT, Bk

S: 8. TS validates the RDP client logon request: a. Validate P2P Root Cert Signature of AT; b. Match DT hash to the DT supplied; c. Match Target Device ID in the DT Envelope; d. Validate Nonce TS; e. Package S[DT, Nonce AAD, Nonce TS]Bk, Bk via cred buffer

T: 9. Network Login (DT cred buffer)

U: grant_type=jwt-bearer&request=eyj..{grant_type=rdp_refresh_token, rdp_assertion=<S[DT, Nonce AAD, Nonce TS]Bk,>, cnf=<Bk_pub>}

V: a. Validate Device signature, match device in DT and device cert; b. Validate Client Binding Key signature, use the binding key from DT; c. Validate nonce

W: kerberos_top_level_names=windows.net&refresh_token=<PRT>&..&tgt_client_key=xxx&tgt_key_type=18&tgt_message_buffer=xxx&tgt_cloud=xxx

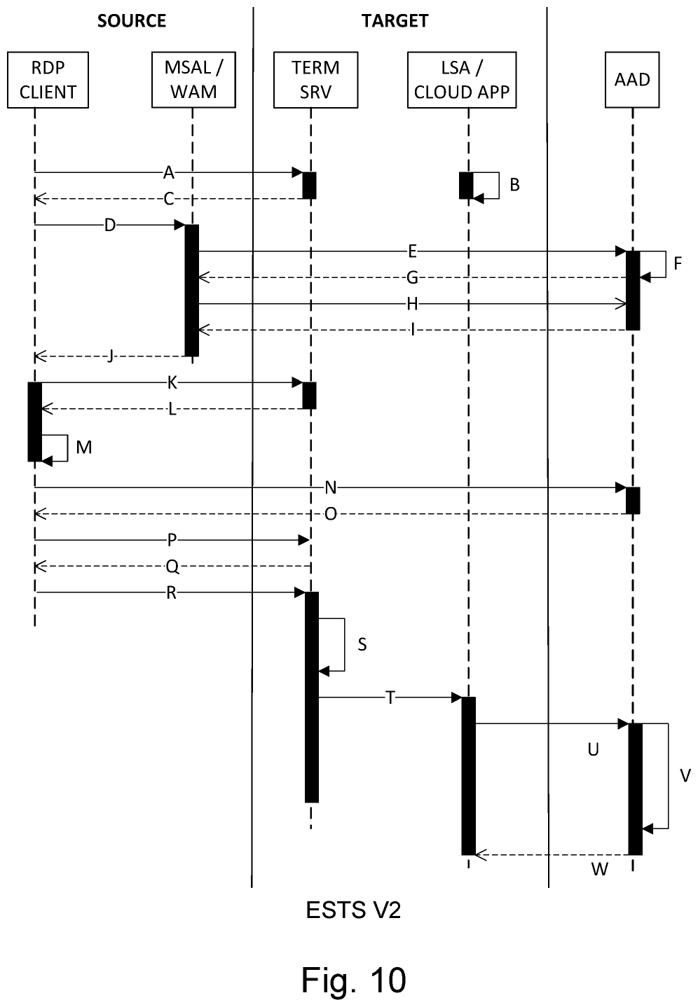

FIG. 10 (eSTS v2)

A: 1. Negotiate Protocol Version

B: 0. Update device P2P cert

C: V4

D: 2. Request Delegation Token; SHA256(Client Binding Key Pub)

E: 3. /authorize?target_device_hostname

F: a. Find Target device in the directory by FQDN; fail if multiple found. b. If PRT found; interrupt for username-password. c. [Pending] If required to show device-consent; interrupt.

G: auth-code

H: /token?token_type=rdp&req_cnf=<client-binding-key-pub>

I: token_type=rdp&access_token=eyj..&x5c_ca=<tenant P2P root cert>

J: Tenant P2P Root Cert, AT

K: 4. TLS Handshake

L: Target Device P2P Cert

M: a. Validate Target Device P2P Certificate; b. Validate Target Device ID

N: 5. Request nonce

O: Nonce AAD

P: 6. Request Nonce

Q: Nonce TS

R: 7. S[AT, Nonce AAD, Nonce TS]Bk+Bk

S: 8. TS validates the RDP client logon request: a. Validate P2P Root Cert Signature of AT; b. Match Target Device ID in the DT Envelope; c. Validate Nonce TS; e. Package S[AT, Nonce AAD, Nonce TS]Bk, Bk via cred buffer

T: 9. Network Login (DT cred buffer)

U: grant_type=jwt-bearer&request=eyj..{grant_type=rdp_refresh_token, rdp_assertion=<S[AT, Nonce AAD, Nonce TS]Bk,>,cnf=<Bk_pub>}

V: a. Validate Device signature; b. Validate P2P root signature of AT; c. Validate target-device: match device in rdp_bt and device cert; b. Validate Client Binding Key signature, use the binding key from rdp_bt; c. Validate AAD nonce

W: kerberos_top_level_names=windows.net&refresh_token=<PRT>&..&tgt_client_key=xxx&tgt_key_type=18&tgt_message_buffer=xxx&tgt_cloud=xxx

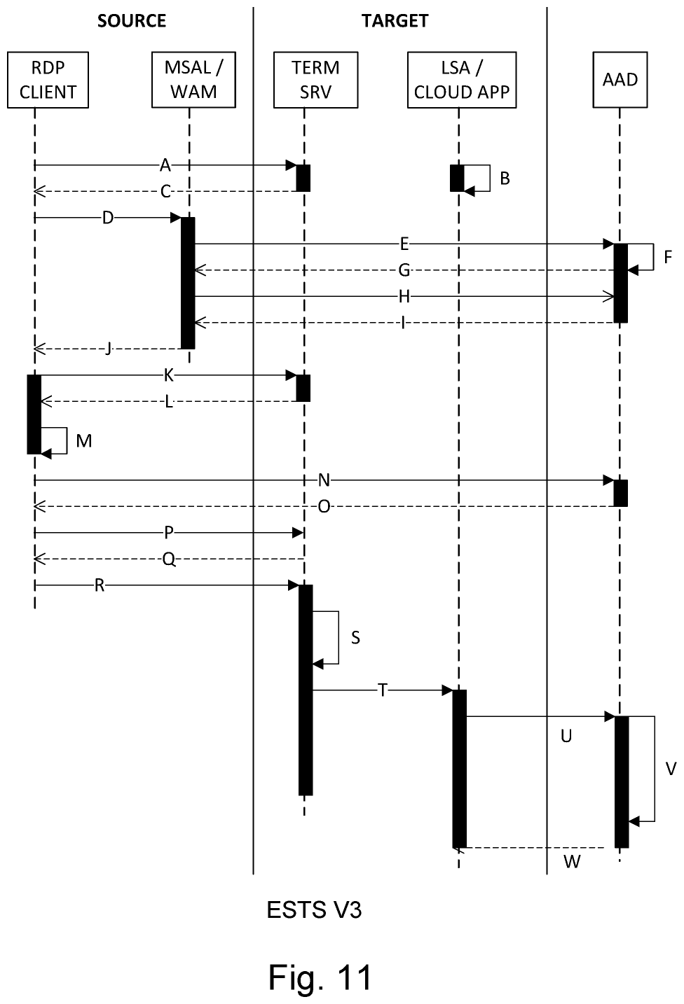

FIG. 11 (eSTS v3)

A: 1. Negotiate Protocol Version

B: 0. Update device P2P cert

C: V4

D: 2. Request Delegation Token; SHA256(pub_Bk)

E: 3. /authorize?scope=ms-device-service://<TS URI>/name/<target_device_hostname>

F: a. Find Target device in the directory by FQDN; fail if multiple found. b. If PRT found; interrupt for username-password. c. If required to show device-consent; interrupt.

G: auth-code

H: /token?req_cnf=<pub_Bk>&scope=ms-device-service://<TS URI>/name/<target_device_hostname>

I: token_type=pop&access_token=<rdp AT[rdp BT]>&id_token=<IDT[x5c_ca:tenant P2P root cert]>

J: Tenant P2P Root Cert, AT:BT

K: 4. TLS Handshake

L: Target Device P2P Cert

M: a. Validate Target Device P2P Certificate; b. Validate Target Device ID

N: 5. Request nonce

O: Nonce AAD

P: 6. Request Nonce

Q: Nonce TS

R: 7. a. Create S[AT, Nonce AAD, Nonce TS, Pub_Bk]Bk; b. Call TermSery with signed envelope

S: 8. a. Validate signature of signed envelope using Pub_Bk; b. Validate P2P Root Cert Signature of AT; c. Match cnf_kid from AT and Pub_Bk; d. Match Target Device ID in AT; e. Validate Nonce TS; f. Package S[AT, Nonce AAD, Nonce TS, Pub_Bk]Bk via cred buffer

T: 9. Network Login (DT cred buffer)

U: grant_type=jwt-bearer&request=eyj..{grant_type=rdp_token, rdp_assertion=<S[AT, Nonce AAD, Nonce TS, Pub_Bk]Bk}

V: a. Validate Device signature; b. Parse BT from AT; c. Validate target-device: match device in bt and device cert; d. Match req_cnf from BT==Pub_Bk; e. Validate AAD nonce

W: kerberos_top_level_names=windows.net&refresh_token=<PRT>&..&tgt_client_key=xxx&tgt_key_type=18&tgt_message_buffer=xxx&tgt_cloud=xxx

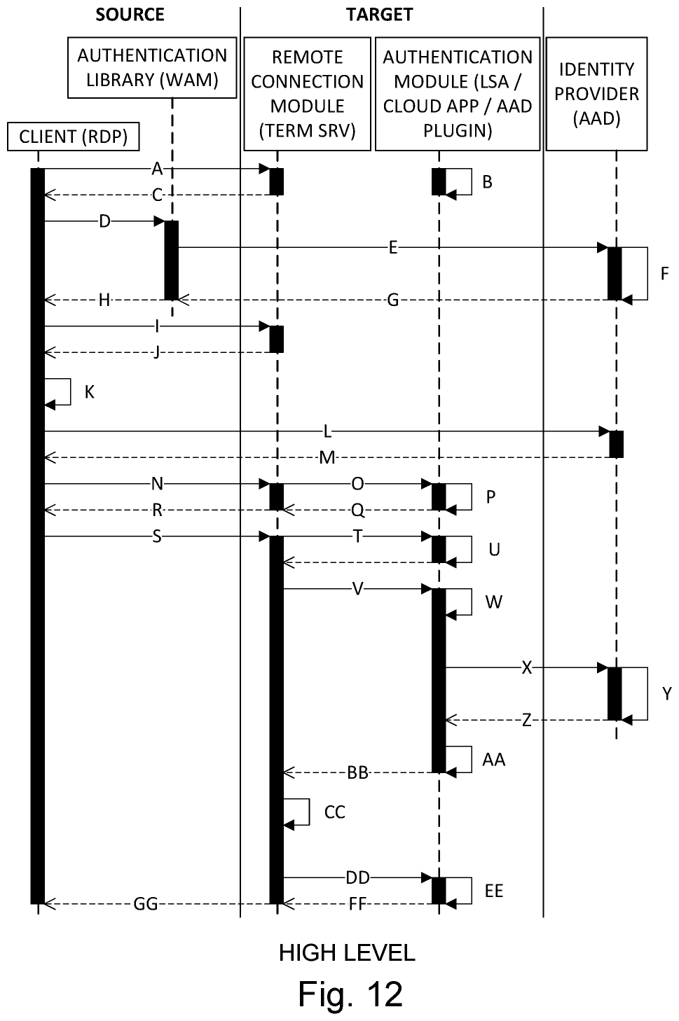

FIG. 12 (High Level)

A: 1. Negotiate Protocol Version

B: 0. Update device P2P cert

C: Out: Modern RDP Protocol, Version 1.0

D: 2. Request Bootstrap Token; In: SHA256(Client Binding Key Pub/Bk), Target Device FQDN \ Device ID

E: 3. Request bootstrap token In: UserCreds; SHA256(Client Binding Key Pub/Bk); Target Device FQDN \ Device ID

F: Find Target device in the directory by FQDN

G: Out: BT[SHA256(Bk), User ID (RT)]; Tenant P2P Root Cert; S[SHA256(DT), Target Device ID, User ID, Tenant ID, SHA256(Bk)]P2P Root Cert

H: Out: BT Envelope; Tenant P2P Root Cert, AT

I: 4. TLS Handshake

J: Target Device P2P Cert

K: a. Validate Target Device P2P Certificate; b. Validate Target Device ID

L: 5. Request nonce

M: Nonce AAD

N: 6. Request Nonce

O: Call Package—Request Nonce

P: Generate TS Nonce (e.g., out: json: TS nonce(base64(E(TS time))))

Q: Nonce TS

R: Nonce TS

S: 7. S[BT, Nonce AAD, Nonce TS]Bk; AT, Bk

T: Call Package—Validate binding

U: 8. Validate the RDP client logon request (e.g., validate TS nonce, AT, binding key, RDP Assertion signature, create RDP Assertion Auth buffer)

V: 9. Network Logon (BT cred buffer) LogonType: Network

W: 10A. Attempt Cache Logon (e.g., Unpack BT Auth buffer, derive a cache key from BT, try to unlock cache, ValidateUserInfo(cache blob), validate tokens in the cache blob with cache usage restricted to, e.g., one hour max)

X: (if 10A fails) 10B. Online Network Logon In: S[S[BT, Nonce AAD, Nonce TS]Bk, Bk]DK (e.g., Network logon, sign RDP Assertion with Device Key (Dk), S[RDP Assertion]Dk)

Y: a. Validate AAD nonce; b. Validate Client Binding Key signature (use the binding key from BT); c. Validate Device signature (match device in BT and device cert); d. Issue PRT and TGT

Z: Out: PRT; TGT

AA: Encrypt and save cache

BB: 11. NT Token

CC: 12. Authorization a. Check that user SIDs in the NT Token and P2P User Cert are the same; b. Authorize the user

DD: 13 Winlogon logon/unlock LogonType: Interactive

EE: Repeat response to Step 9. Network Logon

FF: NT Token

GG: OK

### ADDITIONAL EXAMPLES AND OBSERVATIONS

Additional support for the discussion of remote access herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, additional examples and observations are offered.

Some embodiments use or provide functionality along the following lines. It will be understood that particular modules or services named herein may be exchanged with others that provide the same or roughly similar capabilities with regard to remote access support, and that particular time periods may vary between embodiments.

In some embodiments, CloudAP updates a P2P device certificate on a target device every 8 hours, and when the device reboots. This functionality is usable, e.g., for pku2u NLA handshake. An RDP client negotiates a protocol version with TermSrv on the target device. In this example, TermSrv picks the TLS-based protocol and replies with the protocol version.

The RDP client requests a Delegation Token (DT) from WAM on platforms that have it, or an MSAL library on other platforms. The RDP client generates a binding key pair using RSA (Rivest Shamir Adleman), Elliptic Curve Cryptography, or other cryptographic techniques and includes the public key into the token request. The client also provides the hostname\FQDN or IP address of the device the user is trying to connect to. There may also be an ability for the client to specify a target device ID if it is known.

In this example, the AAD client auth library (WAM) handles the DT token request. AAD server pulls the target device record from the directory. AAD server validates that there are no duplicate devices in the directory. AAD server mints a delegation token (DT). DT is bound to the target device and contains the Client Binding Key generated as noted above. The AAD server also creates an additional json token containing the DT or a hash of the DT, target device ID, user ID\SID, and signs it with the P2P Root Cert. This json token is also referred to in this example as “AT”. The response contains a DT, AT, and the Tenant Root P2P certificate.

In this example, the Request parameters include: User credential (auth code during UI logon, PRT assertion); Target device host name or device ID; Client binding public key (RSA).

In this example, the Response includes: Delegation Token DT (an optional refresh token, contains user ID, target device ID, client device ID (if available), binding key, a claim indicating the client is remote (optional, if client device id is not known); RDP Server Access Token AT (a JWT, signed by the tenant P2P root certificate. Token contains audience: target device ID, issuance date time, expiration time, client device ID (if available), user ID, user SID, user on-prem SID (if available, hash of the delegation token above); the Tenant P2P Root cert; and an ID Token (a JWT, contains the target device ID).

In order for WAM to work without changes on the down-level clients the DT+RDP Server Access Token response part is be returned in a form of one single JSON blob. In this case WAM will be able to handle it as it was a token. Tenant P2P certificate can be part of the ID token.

Next, the RDP client and server establish a TLS connection. The RDP client validates that Target device P2P certificate is signed with the tenant root cert, and the RDP client matches devices in the AAD responses with the target device P2P certificate.

The RDP client requests a nonce from AAD; this the “Nonce AAD”. The RDP client also requests a nonce from Terminal-Service; the “Nonce TS”. The nonce requests may be concurrent, or either request may be made first.

The RDP client signs the AT and the nonces with the client binding key and sends them over to the TermSrv service running on the target device. In this example, the RDP client sends the following items to TS: Delegation token in AT, Nonce AAD, Nonce TS, DT+Nonce AAD+Nonce TS signature, and AT (the RDP Server Access token).

TermSrv validates the RDP client request (this may be referred to as RDP server pre-authorization steps): The RDP server validates the AT. This validates that user and server belong to the same tenant, as a precaution (some embodiments omit this requirement). The RDP server matches the delegation token from the AT to the delegation token sent by the client. This is to make sure that DT or AT were not changed by the client. The RDP Server compares the target device in the AT to the server's device ID. This validates that AT and DT are bound to the target device. The RDP Server validates the TS-Nonce, to prevent replay-attacks. This would help TS to validate the request before launching LSA logon. Then DT, AAD-nonce and the DT+AAD-nonce signature are packaged into a cred buffer.

Next, TermSery performs a network logon with the cred buffer.

In a Logon request, LSA will derive a key from the DT. In a non-cached-request if the DT is new, LSA will perform an interactive logon: CloudAP plugin crafts a logon request with the DT and the AAD nonce. The request is signed with the device key. On the server side: AAD server validates the device key signature and checks that the key used for signing belongs to the same device the DT is bound to. AAD server extracts the client key form the DT key and validates the client key signature. AAD server validates DT and AAD-nonce. In a cached-logon request if the key can be used to decrypt the cache, LSA will perform a cached-logon-request and create an async call to AAD to refresh the PRT.

Next, TermSrv receives NT token from LSA. Then TermSrv completes the user authorization and launches an interactive logon which connects user to the session. This may be done with an existing NT Token or by doing an interactive logon with the same cred buffer, for example.

Technical Character

The technical character of embodiments described herein will be apparent to one of ordinary skill in the art, and will also be apparent in several ways to a wide range of attentive readers. Some embodiments address technical activities such as digital identity authentication 522, inter-computer communications 404, 408, 502, 504, 518, and remote access 204, which are each an activity deeply rooted in computing technology. Some of the technical mechanisms discussed include, e.g., cryptologic signing certificates 308, binding key pairs 326, transport protocols 310, delegation tokens 314, access tokens 318, and credentials 336. Some of the technical effects discussed include, e.g., establishing an authentic presence 210 on a remote computer 206, avoiding 508 password transmissions, and re-authentication 522 based on cached 520 credentials 336. Thus, purely mental processes and activities that are limited to pen-and-paper are clearly excluded. Other advantages based on the technical characteristics of the teachings will also be apparent to one of skill from the description provided.

Some embodiments described herein may be viewed by some people in a broader context. For instance, concepts such as convenience, reliability, and trust may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to securely establish an authentic remote presence on a computer 206 which has no pre-existing credentials 336 recognized in a security domain 214. Other configured storage media, systems, and processes involving convenience, reliability, or trust are outside the present scope. Accordingly, vagueness, mere abstractness, lack of technical character, and accompanying proof problems are also avoided under a proper understanding of the present disclosure.

### ADDITIONAL COMBINATIONS AND VARIATIONS

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, operating environments, time period examples, software processes, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

In some embodiments, a remote desktop protocol uses Oauth-compatible tokens issued by Azure® AD instead of using Kerberos, NTLM or PKU2U, which have inherent limitations (mark of Microsoft Corporation). Instead of passing the credentials over the remote desktop channel to the target device, an OAuth token is passed to the target device to validate a user's credentials. This innovation enables users to use any type of credential 336 (e.g., password, smartcard, biometric, Fast Identity Online (FIDO) specification compliant, passwordless sign in with an authenticator app, or any future method) to establish a remote desktop connection.

### Acronyms, Abbreviations, Names, and Symbols

Some acronyms, abbreviations, names, and symbols are defined below. Others are defined elsewhere herein, or do not require definition here in order to be understood by one of skill.
AAD: Azure® Active Directory® (marks of Microsoft Corporation)
ALU: arithmetic and logic unit
API: application program interface
AT: access token
BIOS: basic input/output system
BK: binding key pair
BKpub: public key of binding key pair
BT: bootstrap token
CD: compact disc
CPU: central processing unit
DK: device key
DT: delegation token
DVD: digital versatile disk or digital video disc
FPGA: field-programmable gate array
FPU: floating point processing unit
FQDN: fully qualified domain name
GPU: graphical processing unit
GUI: graphical user interface
IaaS or IAAS: infrastructure-as-a-service
ID: identification or identity
JSON: JavaScript® Object Notation (mark of Oracle America, Inc.).
JWT: JSON web token
LAN: local area network
LSA: local security authority
MSAL: Microsoft authentication library
NLA: network level authentication
NT token: Windows NT® token (mark of Microsoft Corporation)
NTLM: Windows NT® Lan Manager
OS: operating system
PaaS or PAAS: platform-as-a-service
P2P: peer-to-peer
PKU2U: public key cryptography based user-to-user authentication
PRT: primary refresh token
RAM: random access memory
RDP: remote desktop protocol
ROM: read only memory
S[DT, Client BKpub, User SID]BKpriv: signed envelope containing delegation token, public key of binding key pair of client, and user security ID
SHA256: a cryptographic hash function
SSH: secure shell protocol
SSL: secure sockets layer
TGT: ticket granting ticket
TLS: transport layer security
TPU: tensor processing unit
TS: terminal server
UEFI: Unified Extensible Firmware Interface
WAM: web account manager
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Remote access operations such as generating 402 binding keys, digitally signing 406 tokens, and many other operations discussed herein, are understood to be inherently digital. A human mind cannot interface directly with a CPU or other processor, or with RAM or other digital storage, to read and write the necessary data to perform the remote access steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(5)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as acquiring, authenticating, caching, generating, getting, obtaining, providing, sending, signing, utilizing, validating (and acquires, acquired, authenticates, authenticated, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment
102 computer system, also referred to as a “computational system” or “computing system”, and when in a network may be referred to as a “node”
104 users, e.g., user of an enhanced system 202
106 peripherals
108 network generally, including, e.g., LANs, WANs, software-defined networks, clouds, and other wired or wireless networks
110 processor
112 computer-readable storage medium, e.g., RAM, hard disks
114 removable configured computer-readable storage medium
116 instructions executable with processor; may be on removable storage media or in other memory (volatile or nonvolatile or both)
118 data
120 kernel(s), e.g., operating system(s), BIOS, UEFI, device drivers
122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, and so on
124 applications, e.g., word processors, web browsers, spreadsheets, games, email tools, commands
126 display screens, also referred to as “displays”
128 computing hardware not otherwise associated with a reference number 106, 108, 110, 112, 114
202 system 102 enhanced with remote access functionality, e.g., functionality to perform any operation or operational sequence shown in any of the Figures and first described herein; also referred to as “source” or “client”
204 access; noun or verb
206 target computing system; also referred to as “target”; may be enhanced by credentials described herein or by code to perform functionality described in FIGS. 4-12
208 binding, binds, bound, etc.; functional limitation effected computationally which ties two computers 102 to one another; in some embodiments, binding to target is accomplished by embedding a target device's identifier in a token (e.g., in both delegation and access tokens); some embodiments use two forms of binding, namely, binding the token to a target device and binding the token to a proof-of-possession key, which together can be viewed as binding source and target
210 identity, presence, in the cybersecurity sense
212 identity provider or other software which checks credentials 336
214 security domain, e.g., cloud, cloud tenancy, realm within which a given identity provider operates, or other cybersecurity realm
302 mobile platform program, e.g., smartphone application or mobile device browser
304 website program, e.g., SaaS or web application hosted on-premises or on the Internet; some embodiments operate within web browsers without any reliance on installation of an application on a mobile device
306 nonce; digital data structure with, e.g., an arbitrary number from a cryptographically secure pseudo-random generator; nonces may be used for replay prevention; in some embodiments, bearer tokens (usable without a proof-of-possession key) are used instead of nonces
308 signing certificate; digital data structure
310 transport protocol, e.g., TLS, SSL, SSH, PKU2U, IPSec
312 cloud, e.g., cloud computing environment
314 delegation token; may also be referred to as “DT”, “bootstrap token”, “BT”, or “transfer token”; digital data structure
316 target identifier; digital data structure identifying target 206
318 access token; digital data structure
320 nested access token; digital data structure
322 virtual machine (VM); digital data structure
324 session transfer artifact; digital data structure; in some embodiments the delegation token allows a target device to obtain its own authenticated session; some embodiments use a transferable refresh token, some use an OAuth 2.0 on-time use authorization code, some use another session artifact such as a transferable session cookie, or server-side session in a cache or database that the client holds a pointer to
326 binding key pair; digital data structure
328 source identifier; digital data structure identifying source 202
330 signed envelope; digital data structure
332 computing architecture, e.g., arrangement or configuration of one or more computing devices 102
334 computational protocol version; digital data structure
336 digital credential; digital data structure
400 flowchart; 400 also refers to remote access methods illustrated by or consistent with the FIG. 4 flowchart
402 computationally generate a binding key or a binding key pair, e.g., by execution of cryptologic software
404 computationally obtain a nested access token, e.g., by network 108 communication
406 computationally sign a digital data structure, e.g., by execution of cryptologic software
408 404 computationally send a signed data structure, e.g., by network 108 communication
500 flowchart; 500 also refers to remote access methods illustrated by or consistent with the FIG. 5 flowchart (which incorporates the steps of FIGS. 4 and 6 through 12)
502 computationally acquire a nonce, e.g., by network 108 communication
504 computationally get a signing certificate, e.g., by network 108 communication
506 computationally provide credentials, e.g., by steps illustrated in one or more of FIGS. 6 through 12
508 avoid sending a password
510 computationally send a password, e.g., by network 108 communication
512 password or pass phrase; digital data structure
514 computationally validate a digital signature, e.g., by execution of cryptologic software; in some embodiments the RDP client validates that the TLS channel is signed with the root certificate, and the RDP server validates that the access token is signed with the cert; either a tenant-specific or a global certificate can be used in some embodiments
516 digital signature
518 computationally utilize a transport protocol, e.g., to transport a certificate over a network 108
520 computationally cache in memory a token or other credential(s)
522 computationally authenticate an access attempt using one or more tokens as credential(s)
524 any step discussed in the present disclosure that has not been assigned some other reference numeral

### CONCLUSION

In short, the teachings herein provide a variety of remote access functionalities which operate in enhanced systems 202 or 206 or both. Authentic remote presence 210 for a user 104 who is located at a source computer 202 is established at a target computer 206 without requiring transmission of the user's password from the source computer to the target computer. In some cases remote presence may be established without requiring that the user be previously credentialed at the target. The presence established at the target computer will be recognized by a security domain identity provider 212 as authentic, allowing the user to work remotely on the source computer as if the user was physically present at the target computer even when the source and target are miles apart. The remote access presence 210, 204 may be bound 208 to the particular source and target computers, such that the presence credentials 336 can only be used for remote access from the source through the target into the security domain 214. The remote access functionality will work with a wide variety of operating systems 120, on both desktop and mobile platforms.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware into software. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 4 through 12 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A source computing system (“source”) configured for providing credentials to establish a presence at a target computing system (“target”), the presence configured for authentication to a security domain having an identity provider computing system (“identity provider”), the source comprising:
a digital memory;
a processor in operable communication with the digital memory, the processor configured to perform remote presence establishment steps including generating a binding key pair configured to bind the source with the target, obtaining a nested access token formed by the identity provider based on at least the binding key pair and a target identifier, signing at least the nested access token with the binding key to produce a signed envelope, and sending the signed envelope to the target to provide the target with one or more credentials which support the presence at the target.

2. The source computing system of claim 1, wherein the nested access token comprises a delegation token formed based on at least the binding key pair and an access token based on at least the target identifier.

3. The source computing system of claim 2, wherein the delegation token comprises a session transfer artifact.

4. The source computing system of claim 2, wherein the delegation token comprises a source identifier which is unique to the source.

5. The source computing system of claim 1, wherein the nested access token is signed with at least one of the following: a cloud tenant root certificate, a global identity provider certificate.

6. The source computing system of claim 1, wherein at least one of the following architecture conditions is satisfied:
the source is configured for operation as a client in a client-server computing architecture;
the source is configured for operation as a peer in a peer-to-peer computing architecture;
the source is configured for operation as a cluster or a portion of a cluster in a cluster computing architecture;
the source is configured for communication with the target in a cloud computing architecture;
the source and target include respective machines which are physically separated from one another by at least ten feet;
the target comprises a virtual machine;
the target and source reside in different security domains;
the target and source reside in different security domains on a single machine; or
the source comprises a virtual machine.

7. The source computing system of claim 1, wherein at least one of the following architecture conditions is satisfied:
the source is configured for operation using a different kind of kernel than the target; or
the remote presence establishment steps are kernel agnostic.

8. A method for providing credentials to establish a remote presence configured for authentication to a security domain, the method comprising:
generating a binding key pair configured to bind a source computing system with a target computing system;
obtaining a nested access token based on at least the binding key pair and a target identifier;
acquiring an identity provider nonce;
acquiring a target nonce;
producing a signed envelope at least in part by digitally signing the nested access token, the identity provider nonce, and the target nonce together using the binding key; and
electronically sending the signed envelope toward the target computing system.

9. The method of claim 8, further comprising:
getting a cloud tenant root certificate; and
validating that at least a target identifier portion of the nested access token has been signed using the cloud tenant root certificate.

10. The method of claim 8, further comprising utilizing a certificate transport protocol that comprises a transport layer security handshake.

11. The method of claim 8, further comprising the target computing system being authenticated to the security domain using the nested access token.

12. The method of claim 8, wherein the method provides one or more credentials for a user, and wherein the target computer system was free of any valid credentials for the user to authenticate to the security domain prior to the sending of the nested access token to the target computing system.

13. The method of claim 8, wherein the method provides one or more credentials for a user, and wherein the method avoids sending any password of the user from the source computing system to the target computing system.

14. The method of claim 8, wherein the method is performed by a website program.

15. The method of claim 8, wherein the method is performed by a mobile platform program.

16. A computer-readable storage device configured with data and instructions which upon execution by a processor perform a method for providing one or more credentials to establish a remote presence configured for authentication to a security domain, the method comprising:
generating a binding key pair configured to bind a source computing system with a target computing system;
obtaining a nested access token based on at least the binding key pair and a target identifier;
acquiring an identity provider nonce;
acquiring a target nonce;
producing a signed envelope at least in part by digitally signing the nested access token, the identity provider nonce, and the target nonce together using the binding key; and
electronically sending the signed envelope toward the target computing system.

17. The storage device of claim 16, wherein the method provides one or more credentials which are specifically effective for the target computing system in that the credentials are ineffective for authentication to the security domain of any computing system which is not the target computing system, and the credentials are effective for authentication by the target computing system to the security domain.

18. The storage device of claim 16, wherein the method further comprises:
caching the nested access token at the target computing system; and
authenticating to the security domain using the cached nested access token.

19. The storage device of claim 16, wherein at least one of the following reside in a cloud: the source computing system, or the target computing system.

20. The storage device of claim 16, wherein the method further comprises negotiating a protocol version.
